(19) United States
(12) Patent Application Publication
(10) Pub. No.: US 2025/0218199 A1
(43) Pub. Date: Jul. 3, 2025

(54) ZERO-FRICTION EXIT EXPERIENCE VIA COMPUTER VISION

(71) Applicant: Walmart Apollo, LLC, Bentonville, AR (US)

(72) Inventors: Feiyun Zhu, Plano, TX (US); Wei Wang, Dallas, TX (US); Lingfeng Zhang, Flower Mound, TX (US); Colin Grant Mitchell, Wills Point, TX (US); Yanmei Jin, Dallas, TX (US); Huanyu Zang, Dallas, TX (US); Xin Ma, Arlington, TX (US); Michael Alvin Schubert, JR., Sulphur Springs, AR (US); William Craig Robinson, Centerton, AR (US); Zhaoliang Duan, Frisco, TX (US); Mingquan Yuan, Flower Mound, TX (US); Nilesh Pandey, Santa Clara, CA (US); Han Zhang, Allen, TX (US); Ketan Shah, Dallas, TX (US); Paul Lewis Lobo, Mumbai (IN)

(21) Appl. No.: 18/990,377

(22) Filed: Dec. 20, 2024

Related U.S. Application Data
(60) Provisional application No. 63/616,417, filed on Dec. 29, 2023.

(51) Int. Cl. G06V 20/64; G06V 10/26; G06V 20/52

(52) U.S. Cl. CPC G06V 20/64; G06V 10/26; G06V 20/52

(57) ABSTRACT

Examples provide a system and method for identifying unpaid items in real-time using computer vision object detection and recognition models. Images of a cart are selected based on proximity of the cart to one or more anchor points. The object detection and recognition models analyze the image data and identify a set of items in the selected cart. An e-receipt including a set of paid items is selected from a plurality of active electronic receipts based on matching the set of identified items to the set of paid items. Any unmatched items are added to a set of predicted unpaid items. When a receipt corresponding to the selected e-receipt is scanned, a notification identifying the set of predicted unpaid items is provided to a user device for display, enabling a user to identify any unpaid items in a basket of items quickly and accurately in real-time at store exit.

### BACKGROUND

During transactions in retail facilities, items being purchased by customers are scanned via a scanning device at a point-of-sale (POS), such as a staffed checkout or a self-checkout (SCO). As each item is scanned, a universal product code (UPC) for each item is added to a list of scanned items which are ultimately included in a purchase receipt when the transaction is complete. However, in some transactions, one or more items may inadvertently fail to be scanned, resulting in shrink. To address this issue, an exit greeter can be employed to scan one or more random items in each customer's cart as the customers exit the store. However, this is a time consuming and inefficient process, as only a few items are typically checked while the majority of the items in the cart remain unchecked, resulting in sub-optimal verification of cart contents that is limited in scope. Moreover, this procedure results in increased friction at store exit for customers, as the exit process can create a bottleneck at store exit that can cause unpredictable exit wait times and inconvenience leading to a potentially negative customer experience.

### SUMMARY

Some embodiments provide a system and method for zero-friction unpaid item identification via computer vision. An image of a selected cart is selected from a plurality of images of the selected cart using a set of anchor points associated with a field of view of an image capture device. A plurality of items associated with the selected cart is identified by item detection and item recognition models using the selected image. an item identifier (ID) associated with each item in the plurality of items associated with the selected cart, a set of identified items comprising a plurality of item IDs associated with the plurality of items. An e-receipt associated with the selected cart from a plurality of active e-receipts using a fuzzy matching of a set of paid items included in the selected receipt and the set of identified items generated using the selected image in real time. The set of paid items includes a scanned item ID associated with each item scanned at a POS device during a transaction associated with the selected e-receipt. Each scanned item ID in the set of paid items is mapped to an identified item ID in the set of identified items. An unmapped item in the set of identified items is a predicted unpaid item. Upon receiving a verification request signal associated with the selected receipt from a scanner device indicating a user is ready to exit, generate a notification including a verification result, wherein the verification result includes a set of unpaid items. Each predicted unpaid item in the set of unpaid items is associated with an item having an item ID in the set of identified items that fails to map to a corresponding item ID in the set of scanned items. The notification is sent to a user interface device associated with the scan device via a network. The notification includes a list of items in the set of paid items and a list of items in the set of unpaid items enabling near zero-friction item verification at exit via real-time computer vision object detection and recognition.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for identifying unpaid items using object detection and object recognition models in real-time in cart exit area.

FIG. 2 is an exemplary block diagram illustrating a retail environment including a POS device and a set of cameras for capturing data used during identification of unpaid items.

FIG. 3 is an exemplary block diagram illustrating an unpaid item manager for real-time identification of unpaid items.

FIG. 4 is an exemplary flow chart illustrating operation of the computing device to identify unpaid items in real-time using computer vision detection and recognition results.

FIG. 5 is an exemplary flow chart illustrating operation of the computing device to select images of a cart for use in identifying unpaid items.

FIG. 6 is an exemplary flow chart illustrating operation of the computing device to generate a notification in response to a verification request.

FIG. 7 is an exemplary diagram illustrating exit CV hardware and camera settings.

FIG. 8 is an exemplary illustration of selecting representative cart images in the trajectory.

FIG. 9 is an exemplary screenshot of a receipt check screen displayed via a UI device.

FIG. 10 is an exemplary screenshot of a scan items notification including a cart image with instructions to scan a sample of the items in the cart associated with the image.

FIG. 11 is an exemplary screenshot of a scan items notification including a cart image with a side view of a cart.

FIG. 12 is an exemplary screenshot of a scan items notification including a cart image with highlighted items for scanning by a user prior to customer exit.

FIG. 13 is an exemplary screenshot of an unscanned items notification displayed via a UI device.

FIG. 14 is an exemplary illustration of a gallery monitoring page displaying a set of paid items and a set of unpaid items.

FIG. 15 is an exemplary illustration of a gallery review page including a list of paid items and a list of unpaid items.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Shrink is an issue troubling retailers worldwide, resulting in over $61B in lost profit every year. At some stores, missed item scans at exit alone can result in millions of dollars in losses attributed to shrink annually. Some stores attempt to reduce shrink by stopping customers as they exit the store and scanning a few random items in their cart. However, this approach has several drawbacks that impede its effectiveness. For example, the process of stopping customers for random scans introduces additional wait times and creates an additional step for customers to perform before leaving the store. This added inconvenience can lead to dissatisfaction among customers. The random checks of every customer's shopping cart can cause embarrassment and discomfort for customers, as it can imply a sense of distrust towards every customer. Such practices can negatively impact overall shopping experience and customer loyalty. It also limits the amount of shrink captured because only a small sample size of items, typically three random items from each cart, are scanned and verified. This method may miss unpaid items that are not among the randomly selected items, leaving potential losses unaddressed. This is inefficient and unreliable method of reducing shrink due to unscanned items.

Referring to the figures, examples of the disclosure enable exit computer vision unpaid item identification for reduced friction exit experience. In some embodiments, an unpaid item manager selects an image of a selected cart from a plurality of images of the selected cart using object tracking, a depth model and tracking trajectory of the cart using a set of anchor points associated with a field of view of an image capture device. In this manner, the system is able to select images having a full view of the selected cart with the optimum images which enable generation of the highest quality detection and recognition model results. This reduces false positives and error rates while improving accuracy of item recognition results.

In some embodiments, when a user completes a purchase transaction, the system maps each scanned item identified in an e-receipt to predicted item IDs for items identified using computer vision (CV) object detection and recognition models. If any item identified by the CV models fails to map to a scanned item included in the list of paid items in the e-receipt, a notification is generated and presented to a user via a user interface device. This enables the user to identify and/or scan missed items quickly and easily with minimal friction prior to exiting the store while reducing shrink resulting from unscanned items remaining at customer exit from the store.

Other aspects provide fuzzy basket matching for identifying an electronic receipt (e-receipt) associated with the identified items in a selected cart. This enables more accurate matching of paid item information obtained from the e-receipt with item recognition data associated with a selected cart while reducing error rates associated with false positives.

In some embodiments provide a mapping component that generates a list of unpaid items by mapping the predicted item identifiers (IDs) for items identified using item detection and recognition models with paid item IDs obtained from a selected e-receipt. This enables fast and efficient identification of unpaid items with zero-friction for customers attempting to checkout and exit a retail facility.

Other embodiments generate a notification including a list of unpaid items and paid items associated with a receipt ID for a basket of items purchased by a customer in real-time as a customer is exiting a retail facility. This enables frictionless exit while providing quick and reliable access to accurate unpaid item lists and paid item lists for each customer basket.

The computing device operates in an unconventional manner by automatically identifying unpaid items for customer baskets using e-receipt data and item recognition results. The results are provided to a user seamlessly in response to a verification request generated upon scanning a receipt associated with the customer basket. In this manner, the computing device is used in an unconventional way and allows accurate and reliable identification of unpaid items without physically scanning items in the customer's basket for prevention of shrink while improving customer exit experience and reducing time spent verifying item payments. The system further reduces system memory usage consumed in storing item scan data and matching scanned items to receipt data during manual verifications of customer baskets at exit.

In other embodiments, the computing device operates in an unconventional manner by presenting a list of unpaid items to a user requesting basket payment verification in real-time after completion of a transaction but before the customer exits the store, thereby enabling the user to quickly identify missed items. This reduces system resources consumed by scanning random items during a manual verification process and reduces the number of missed unpaid items, further improving overall efficiency of human users by eliminating the need to scan random items in a customer cart at exit. The system further reduces human time and effort consumed scanning receipts and matching randomly scanned items to the receipts at exit, reducing queue lines of customers waiting to exit the store.

In some embodiments, computer vision technology is used to capture images of customer carts and identify items within the cart. The system compares recognized items to the items scanned at the POS and/or recorded on the receipt. The system identifies potential shrink and notifies a user or cashier upstream right before the customer exits after the transaction is completed, sending the missed item alert to the tablet of a user and/or another user interface (UI) at the checkout terminal. This enables the user to identify missed items quickly and efficiently at exit.

The system further outputs the verification results to a user via a user interface (UI). The results include a list of unpaid items and/or images of the unpaid items, enabling a user to quickly locate and scan the unpaid items if desired. This improves user efficiency via UI interaction with increased user interaction performance, thereby improving the functioning of the underlying computing device.

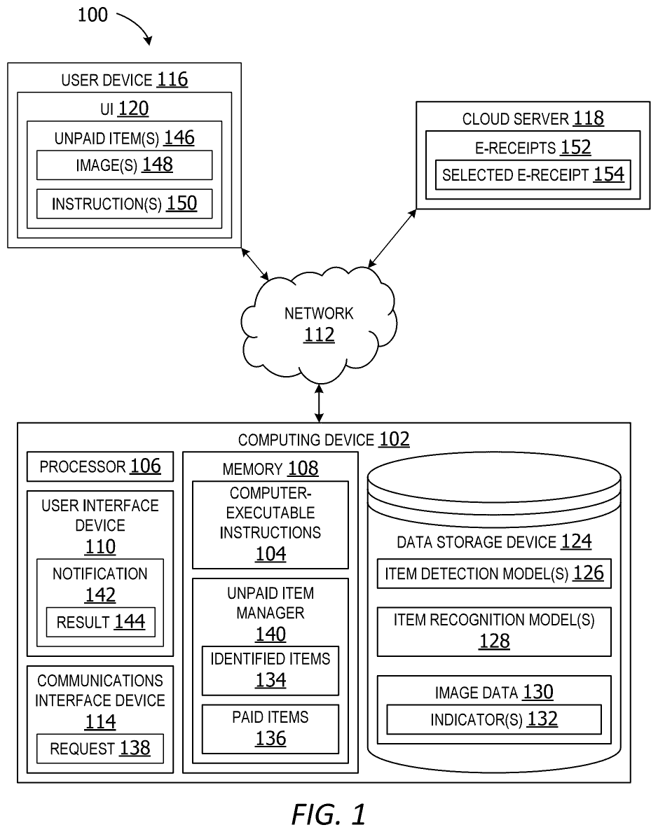

Referring again to FIG. 1, an exemplary block diagram illustrates a system 100 for identifying unpaid items using object detection and object recognition models in real-time in cart exit area. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

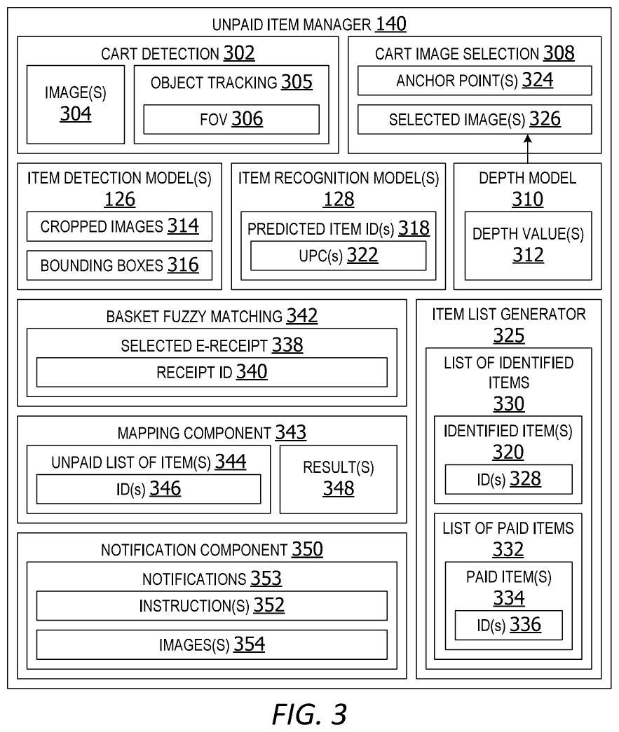

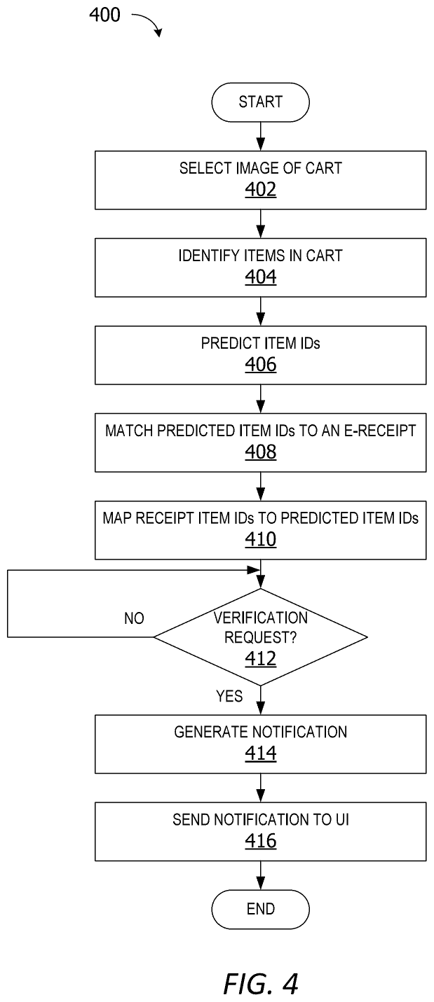

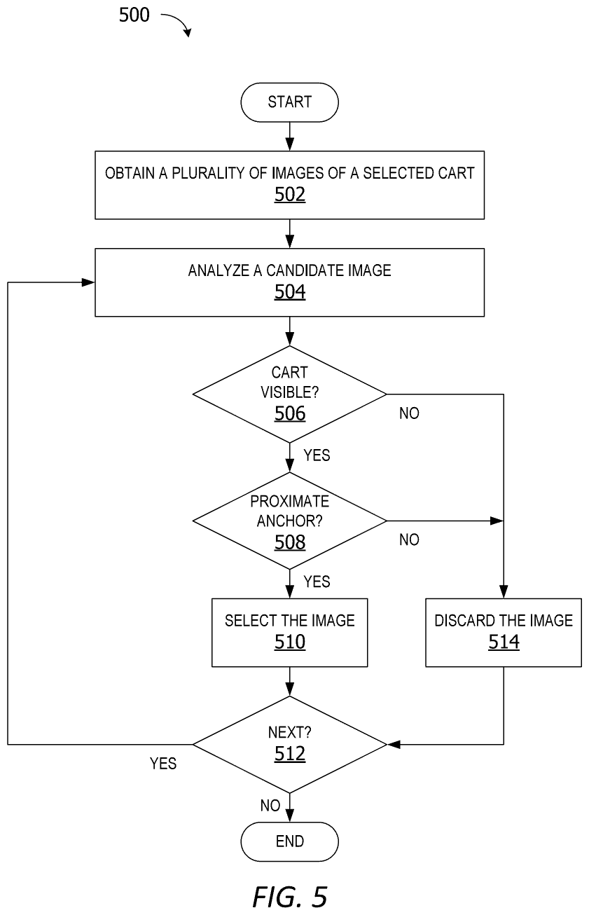

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 3, FIG. 4, and FIG. 5).

The computing device 102 further has one or more computer-readable media such as the memory 108. The memory 108 includes any quantity of media associated with or accessible by the computing device 102. The memory 108 in these embodiments is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 120.

The cloud server 118 is a logical server providing services to the computing device 102 or other clients, such as, but not limited to, the user device 116. The cloud server 118 is hosted and/or delivered via the network 112. In some non-limiting embodiments, the cloud server 118 is associated with one or more physical servers in one or more data centers. In other embodiments, the cloud server 118 is associated with a distributed network of servers.

The system 100 can optionally include a data storage device 124 for storing data, such as, but not limited to one or more item detection model(s) 126, one or more item recognition model(s) 128, and/or image data 130. The image data optionally includes one or more indicator(s) 132 associated with one or more identified items 134. The indicator(s) 132 in some embodiments include color-coded bounding boxes placed around the images of objects, such as a shopping cart and/or items in the shopping cart.

The item detection model(s) 126 are deep learning CV object detection models that are trained to analyze one or more image(s) of a checkout area within a retail environment and identify shopping carts, items in shopping carts shown in the image(s). The detected items are enclosed within bounding boxes in the image(s). The images are cropped to isolate the selected shopping cart identified in the image. The image(s) of the shopping cart are cropped to isolate the one or more item(s) in the shopping cart.

The item recognition model(s) 128 includes one or more trained, CV deep learning item detection models trained to recognize the items detected by the item detection model(s) 126. The item recognition model(s) 128 predicts or infers an item ID for each recognized item. The item ID, in some embodiments, is a universal product code (UPC) associated with the identified item. For example, if the item detection model(s) isolate an item in an image that is recognized as a brand “A” 24-pack of soft drinks, the item recognition model(s) 128 infers an item ID for the brand “A” 24-pack of soft drinks and associates that item ID with the image of the brand “A” 24-pack soft drinks. The item recognition model(s) are trained using labeled image data including images of thousands of items in a catalog of items stocked and/or offered for sale in the retail store.

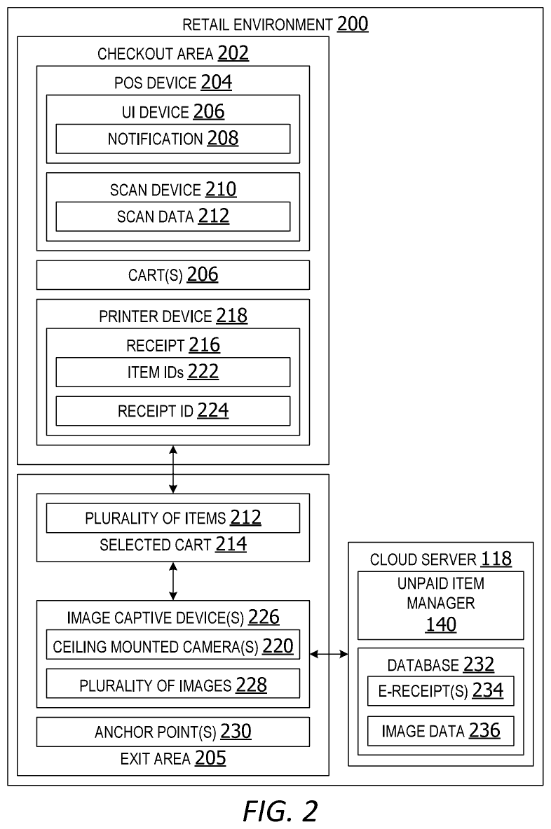

The data storage device 124 can include one or more different types of data storage devices, such as, for example, one or more rotating disks drives, one or more solid state drives (SSDs), and/or any other type of data storage device. The data storage device 124, in some non-limiting embodiments, includes a redundant array of independent disks (RAID) array. In some non-limiting embodiments, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 124 includes a database, such as, but not limited to, the database 232 in FIG. 2.

The data storage device 124, in this example, is included within the computing device 102, attached to the computing device, plugged into the computing device, or otherwise associated with the computing device 102. In other embodiments, the data storage device 124 includes a remote data storage accessed by the computing device via the network 112, such as a remote data storage device, a data storage in a remote data center, or a cloud storage.

The memory 108 in some embodiments stores one or more computer-executable components, such as, but not limited to, an unpaid item manager 140, that, when executed by the processor 106 of the computing device 102, selects one or more image(s) of a selected cart from a plurality of images of the selected cart using a set of anchor points associated with a field of view of an image capture device. The unpaid item manager 140 identifies a plurality of items associated with the selected cart using the selected image(s). The unpaid item manager 140 predicts an item identifier (ID) associated with each item in the plurality of items associated with the selected cart. The unpaid item manager 140 generates a list of identified items 134 and/or a list of paid items 136. The paid items 136 are identified using an e-receipt selected from a plurality of e-receipts.

In some embodiments, the unpaid item manager 140 selects an e-receipt associated with the selected cart from a plurality of active e-receipts 152 using a fuzzy matching of the list of paid items 136 included in the selected e-receipt 154 and the list of identified items 134 generated using the selected image in real time. The paid items 136 include a paid item ID associated with each item scanned at a POS device during a transaction associated with the selected e-receipt. The unpaid item manager 140 maps each paid item ID in the list of paid items 136 to an identified item ID in the list (set) of identified items 134.

An unmapped item in the identified items 134 is a predicted unpaid item. When the unpaid item manager 140 receives a verification request 138 signal associated with the selected receipt from a scan device indicating a user is ready to exit and a verification of the basket contents payment is required. The unpaid item manager 140 generates a notification 142 including a verification result 144. The verification result 144 includes a list of unpaid items 146. Each predicted unpaid item is associated with an item ID in the list of identified items 134 that fails to map to a corresponding item ID in the list of paid items 136. The unpaid item manager 140 sends the notification 142 to a user interface device, such as, but not limited to, the user interface device 110 and/or the UI 120.

The notification includes the list of unpaid item(s) 146 and/or the list of paid items 136. The notification optionally also includes one or more image(s) 148 of the selected cart with an overlay of indicator(s) 132 highlighting the unpaid items. The notification 142 optionally also includes one or more instruction(s) 150, such as an instruction to scan one or more of the unpaid item(s) 146.

In this example, the unpaid item manager 140 is implemented on the computing device 102. However, in other embodiments, the unpaid item manager is implemented on a remote computing device or a cloud server, such as, but not limited to, the cloud server 118, as shown in FIG. 2 below.

In the example shown in FIG. 1, the plurality of e-receipts is stored on the cloud server 118. However, in other embodiments, the e-receipts are optionally stored on a data storage device, such as, but not limited to, the data storage device 124.

FIG. 2 is an exemplary block diagram illustrating a retail environment 200 including a POS device and a set of cameras for capturing data used during identification of unpaid items. The retail environment 200 is an environment including a retail facility, such as, but not limited to, a retail store, a warehouse and/or a distribution center storing and/or displaying items available for purchase or lease by customers. The retail environment includes an indoor area, outdoor area, and/or a partially enclosed area for storing and/or displaying items for retail sale. In this example, the retail environment 200 includes a checkout area 202 and an exit area 205.

The checkout area 202 is an area associated with a POS device 204 for completing a transaction to purchase one or more items associated with one or more cart(s) 206. The checkout area 202 includes staffed checkout lanes and/or unstaffed, self-checkout (SCO) lanes. An SCO is an unstaffed checkout lane. In this example, the POS device 204 includes a scan device 208 for scanning item identifiers codes associated with items, such as, but not limited to, a universal product code (UPC), a radio frequency identifier (RFID) tag, matrix barcode, or any other type of identifier. The scan device 208 generates scan data 210 associated with a plurality of items 212 associated with a selected cart 214.

The POS device 204 generates a receipt 216 associated with the plurality of items scanned by the scan device 208. The receipt 216 includes a physical receipt printed by a printer device 218 and/or an electronic receipt. The receipt 216 includes a list of scanned items and the item IDs 222 associated with the scanned items. In some embodiments, the receipt 216 includes a unique receipt ID 224. The receipt ID in some embodiments is a barcode or other identifier, such as, but not limited to, a UPC, a matrix barcode, or any other type of unique ID. The receipt ID is scanned by a scan device to obtain the receipt ID. The receipt ID is used to retrieve receipt data, including a list of purchased (paid) items on the receipt.

As each receipt is generated, the POS device transmits an e-receipt copy of the receipt to the unpaid item manager 140 via a network, such as, but not limited to, the network 112 in FIG. 1. In this example, the e-receipts 234 received from the POS device 204 are stored in a database 232. The database 232 optionally stores other data, such as, but not limited to, image data 236. The image data includes data associated with one or more digital images in the plurality of images 228, such as image metadata. The image metadata optionally includes a timestamp identifying a time when the image was generated, location data associated with the image capture device, an image capture device ID, and/or any other data associated with the plurality of images 228.

In this example, the exit area includes one or more image capture device(s) 226 generating a plurality of images 228 of the plurality of car(s) 206 and cart contents, such as, but not limited to, the plurality of items 212 associated with the contents of the selected cart 214. The image capture device(s) generates images of the cart(s) as the cart(s) move away from the POS device and toward an exit. As the cart(s) move, they pass one or more anchor point(s) 230. In this example, there are three anchor point(s) 230 used to identify selected images of the selected carts. In other words, the system selects images of the selected cart when the cart is positioned near (in proximity to) an anchor point. The anchor point identifies a location in which a cart is fully within the field of view (FOV) 306 of at least one image capture device, such as a camera mounted to a ceiling of the retail facility.

The unpaid item manager 140 analyzes the image(s) using a depth model to identify a selected cart nearest to the anchor point(s), such as but not limited to, the depth model 310 in FIG. 3. The unpaid item manager uses object tracking to track the selected cart through a sequence of images generated by the image capture device(s), such as, but not limited to, the ceiling mounted camera(s) 220.

The unpaid item manager 140 detects and identifies one or more items in the selected cart 214 via one or more detection and recognition models, such as, but not limited to, the item detection model(s) 126 and/or the item recognition model(s) 128 in FIG. 1.

In other embodiments, the POS device includes a processor and a memory for generating messages transmitted to the unpaid item manager 140, such as, but not limited to, the messages including the e-receipts and/or a verification request message.

FIG. 3 is an exemplary block diagram illustrating an unpaid item manager 140 for real-time identification of unpaid items. In some embodiments, the cart detection 302 obtains one or more image(s) 304 of one or more carts, such as, but not limited to, the cart(s) 206 in FIG. 2. In this example, the cart detection 302 obtains between five and twenty images captured by a camera at an unstaffed (SCO) checkout lane, such as, but not limited to, the image capture device(s) 226 in FIG. 2. However, the embodiments are not limited to using five to twenty images. The cart detection 302 may utilize a single image, as well as two or more images of one or more carts. The cart detection 302 is a software component that employs a cart detection algorithm to isolate and extract a selected cart from one or more images of the cart. An object tracking 305 algorithm is applied to track the same cart through a series of images in a sequence. The cart detection identifies images in which a full and clear view of the selected cart is visible within the FOV 306 of the camera generating the images. Additionally, a depth model 310 estimates depth value(s) 312 for each cart in the image(s) FOV 306, enabling the system to accurately identify the selected cart corresponding to the ongoing transaction. The depth model 310 is a trained deep learning model.

The item detection model(s) 126 applies an item detection algorithm to crop images of items present in the selected cart. This process enables precise localization of items within the captured images. The cropped image(s) 314 are isolated or highlighted by bounding boxes 316 enclosing the detected items within an overlay of the image data, in some embodiments.

The item recognition model(s) 128 apply two item recognition algorithms that are utilized to infer the Universal Product Code (UPC) from the cropped item images. These algorithms facilitate accurate identification and recognition of items in the transaction. The item recognition model(s) generate predicted item IDs 318 for the identified item(s) 320. The identified items include items detected in the images that the item recognition model(s) recognize and infer an item ID. The item IDs, in this example, include one or more item UPC(s) 322.

The depth model 310 includes one or more models trained to generate depth values 312 associated with one or more objects (items) in an image. In this example, the depth model determines a depth value for each shopping cart in an image. The depth values are used to identify a shopping cart which is closest in proximity to the POS device and/or an anchor point in an image. Carts which are located too far away from the anchor points (threshold depth/distance) are discarded or disregarded.

One or more images of the selected cart are selected from a plurality of images of the selected cart by a cart image selection 308. The cart image selection 308 identifies images in which the selected cart is located within a predetermined proximity or range from one or more anchor point(s) 324. The selected image(s) 326 include images in which the cart is fully visible in the FOV of the image capture device without any obstructions visible.

An item list generator 325 generates a set of identified items 320 including the inferred or predicted item ID(s) 328 for each item recognized by the item recognition model(s) 128. A list of identified items 330 is generated by the item list generator 325. The list of identified items 330 includes the predicted item IDs 328 for the set of identified items 320. The item list generator also generates a list of paid items 332 including the item IDs 336 for a set of paid items 334 obtained from a selected e-receipt 338. The selected e-receipt 338 is an electronic receipt selected from a plurality of e-receipts using a basket fuzzy matching 342 algorithm. Each e-receipt is optionally associated with a unique receipt ID 340 used to request verification when the customer receipt is scanned.

By leveraging the computer vision item detection model(s) and the item recognition model(s), in this example, the unpaid item manager generates a list of unpaid items 344 by inferring item ID(s) 346 from the image(s). A mapping component 343 maps the list of identified item IDs to the list of paid item IDs from the selected e-receipt 338 to generate the list of unpaid item(s) 344. The list of unpaid item(s) includes the item ID(s) for identified items in the set of identified items which fail to map to at least one paid item ID in the set of paid items. The list of unpaid item(s) 344 is included in verification result(s) 348 which are stored in a database with the receipt ID for the e-receipt associated with the selected cart.

When the unpaid item manager 140 receives a verification request from a user device, a notification component 350 generates one or more notifications 353 including the list of unpaid item(s) 344. The notification(s) optionally also include one or more instruction(s) 352, such as a scan item instruction, a “green to go” instruction, and/or any other type of instruction. The notification(s) 353 optionally also include one or more image(s) 354 of the unpaid items. The notification component 350 sends the notification(s) to a UI device for display to a user.

In some embodiments, the notification component sends a single notification identifying all the unpaid items or the notification component can send a series of notifications in which each notification identifies a single unpaid item. After each unpaid item is scanned, the new scan data for the scanned item is received triggering the unpaid item manager to send the next notification identifying the next unpaid item that requires scanning. In this manner, the notifications enable the system to walk the user through the process of identifying each unpaid item one at a time and scanning it (adding it to the basket of scanned items).

In some embodiments, these notifications display red bounding boxes, one at a time, on the cart image, effectively highlighting the unpaid items for further attention and resolution. In other embodiments, the notifications include cropped images of each unpaid item. In still other embodiments, the notifications include anchor images of the unpaid item. An anchor image is a stock image or image of an item from a catalog of items.

FIG. 4 is an exemplary flow chart illustrating operation of the computing device to identify unpaid items in real-time using computer vision detection and recognition results. The process 400 shown in FIG. 4 is performed by an unpaid item manager component, executing on a computing device, such as the computing device 102 or the user device 116 in FIG. 1.

The process begins by selecting an image of a cart at 402. The cart is a selected cart, such as the selected cart 214 in FIG. 2. An item detection model and an item recognition model identify items in the cart at 404. The item detection models include one or more item detection models, such as, but not limited to, the item detection model(s) 126 in FIG. 1. The item recognition model predicts item IDs for the detected items at 406. The item recognition model includes one or more CV models, such as, but not limited to, the item recognition model(s) 128 in FIG. 1. The unpaid item manager matches predicted item IDs to an e-receipt at 408. The unpaid item manager maps the receipt item IDs to the predicted item IDs at 410. A determination is made whether a verification request is received at 412. If yes, a notification is generated at 414. The unpaid item manager sends the notification to the UI at 416. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

Referring now to FIG. 5, an exemplary flow chart illustrating operation of the computing device to select images of a cart for use in identifying unpaid items is shown. The process 500 shown in FIG. 5 is performed by an unpaid item manager component, executing on a computing device, such as the computing device 102 or the user device 116 in FIG. 1.

The process begins by obtaining a plurality of images of a selected cart at 502. The plurality of images includes images generated by an image capture device, such as, but not limited to, the image capture device(s) 226 in FIG. 2. The unpaid item manager analyzes a candidate image at 504. A determination is made whether the cart is fully visible within the FOV of the camera at 506. If not, the image is discarded at 514. If the cart is visible, a determination is made whether the cart is proximate to an anchor point in the candidate image at 508. If not, the image is discarded at 514. If the cart is near the anchor, the image is selected at 510. A determination is made whether a next candidate image is available at 512. If yes, the process iteratively executes operations 504 through 512 until all the images are analyzed. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

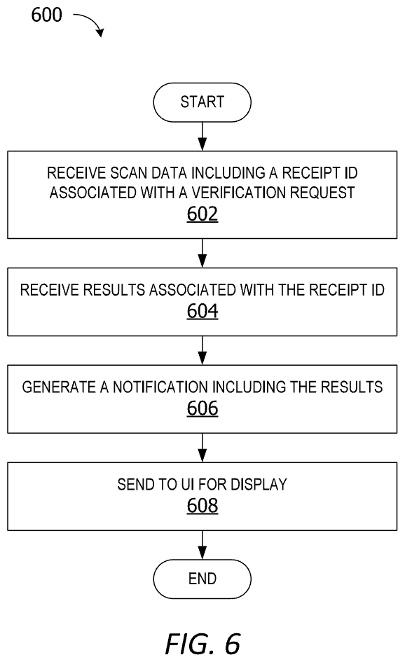

FIG. 6 is an exemplary flow chart illustrating operation of the computing device to generate a notification in response to a verification request. The process 600 shown in FIG. 6 is performed by an unpaid item manager component, executing on a computing device, such as the computing device 102 or the user device 116 in FIG. 1.

The process begins by receiving scan data including a receipt ID associated with a verification request at 602. The scan data is generated by a scan device, such as, but not limited to, the scan device 208 in FIG. 2. The unpaid item manager retrieves results associated with the receipt ID at 604. The unpaid item manager generates a notification including the results at 606. The unpaid item manager sends the notification to a UI for display to a user at 608. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

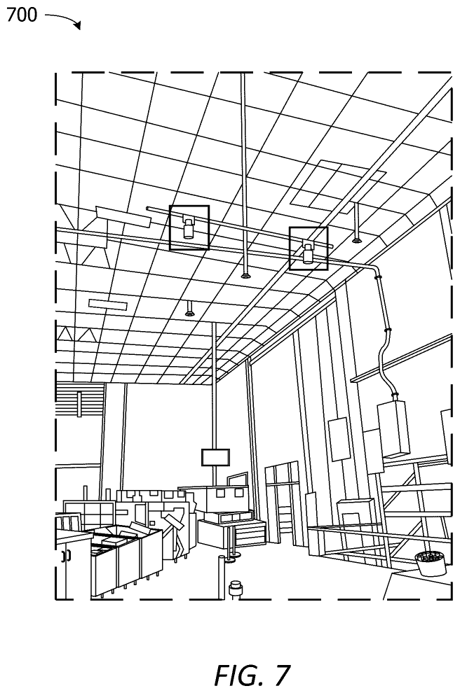

FIG. 7 is an exemplary diagram 700 illustrating exit CV hardware and camera settings. In this example, cameras monitor the exit for scan and go (SNG) and/or self-checkout (SCO) transactions. In this example, two ceiling mounted cameras are shown enclosed within bounding boxes. The cameras are mounted above an exit area in a retail environment. However, the embodiments are not limited to two ceiling mounted cameras. In other embodiments, the system includes three or more cameras mounted to the ceiling. In still other embodiments, the system includes additional other cameras mounted to other fixtures, such as, but not limited to, support pillars, walls, checkout devices, or any other fixture within a retail environment. The cameras and their respective views ensure comprehensive coverage of the exit area.

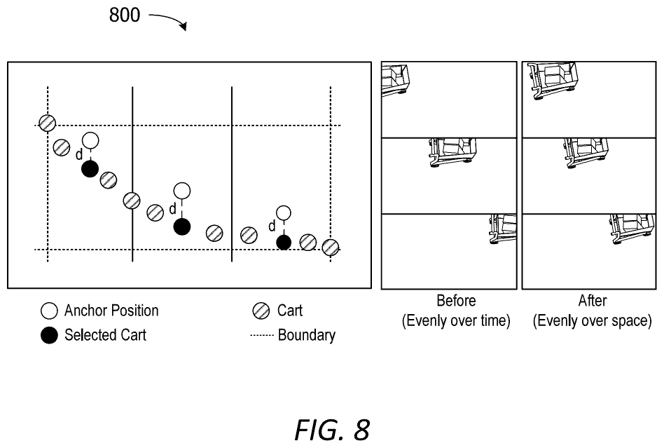

FIG. 8 is an exemplary diagram 800 of selecting representative cart images in the trajectory. The diagram 800 includes cart indicators associated with a trajectory of shopping carts in a series of images relative to a set of three anchor points. In this example, the indicators include colored and/or shaded dots representing carts and anchor positions. The images in which the shopping cart is closest in proximity to the anchor points are the images that are selected.

In other embodiments, the images generated by the cameras are used for basket matching. During the basket matching process, the exit CV system generates a CV item list and skillfully matches it with active candidate receipts, effectively linking cart images generated by the cameras to the respective SNG receipts generated during cart checkout.

For example, if the exit CV system uses images of a customer cart to identify a list of items in the cart including a package of Brand “X” cookies, a package of Brand “Y” chips, a bottle of Brand “Z” soda, and a pineapple, the system attempts to match the list of identified items with a list of scanned items in a customer e-receipt. In this example, a first receipt includes a package of Brand “X” cookies, a package of Brand “Y” chips, a bottle of Brand “Z” soda, and a package of nuts. A second receipt includes paper towels, a package of Brand “X” cookies, a package of Brand “A” chips, and a bottle of water. A third receipt contains hotdog buns, beef ribs, tomatoes, and strawberries. In this example, the system matches the list of identified items captured in the image(s) with the first list of items associated with the first receipt because the items are the closest match.

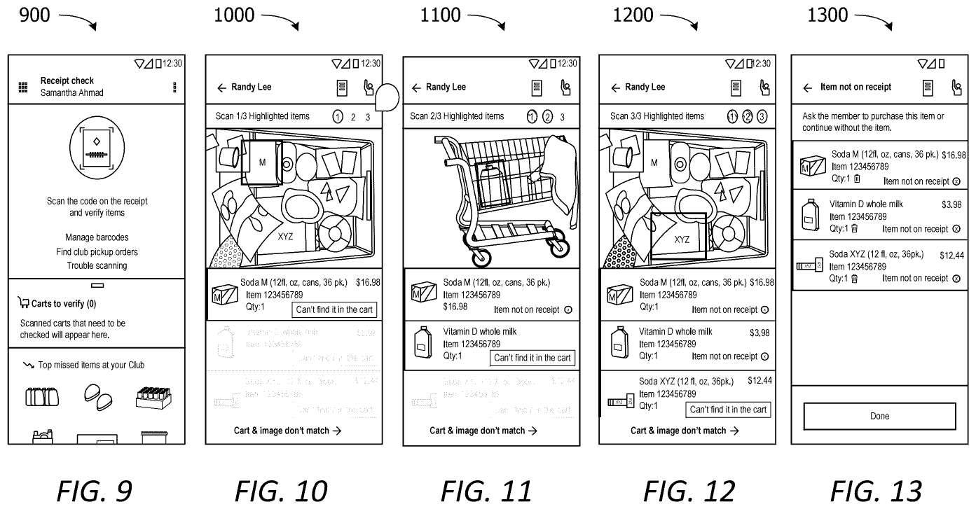

FIG. 9, FIG. 10, FIG. 11, FIG. 12, and FIG. 13 include exemplary set screenshots of a set of notifications displayed via a UI associated with a POS device. The notifications in this example display a list of the unpaid items, an image of the selected cart having the unpaid items highlighted by bounding boxes and/or an anchor image of each item is presented with the name, brand, variety, and other descriptive information associated with each unpaid item.

FIG. 9 is an exemplary screenshot 900 showing a receipt check screen displayed via a UI device. The receipt check screen is displayed to a user performing a receipt check at exit. During receipt check, an authorized user determines whether the items in a shopping cart matches the list of items in the receipt that is matched to the cart by the basket matching process.

FIG. 10 is an exemplary screenshot 1000 of a scan items notification including a cart image with instructions to scan a sample of the items in the cart associated with the image. The notification includes instructions to scan highlighted items in the annotated cart image. The notification is presented to a user performing the receipt check via a user device, such as a tablet.

FIG. 11 is an exemplary screenshot 1100 of a scan items notification including a cart image with a side view of a cart. The notification is presented to a user performing the receipt check via a user device, such as a tablet.

FIG. 12 is an exemplary screenshot 1200 of a scan items notification including a cart image with highlighted items for scanning by a user prior to customer exit. The notification is presented to a user performing the receipt check via a user device, such as a tablet. In this example, the user is instructed to scan items in the cart to ensure the items in the cart are included on the receipt matched to the cart.

FIG. 13 is an exemplary screenshot 1300 of an unscanned items notification displayed via a UI device. The notification is presented to a user performing the receipt check via a user device, such as a tablet. In this example, one or more items in the cart fails to appear on the receipt matched to the cart. These unscanned items should be scanned and paid for or removed from the cart prior to the customer exiting the store or other retail facility with the cart.

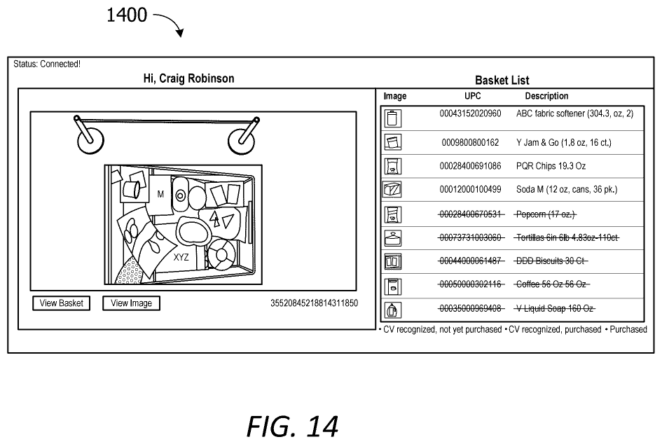

FIG. 14 is an exemplary illustration of a gallery monitoring page 1400 displaying a set of paid items and a set of unpaid items. A user-friendly display on the Gallery monitor page, presenting a clear distinction between a list of paid items shown in “green” and a list of unpaid items shown in “red.” This information is accessible to club associates for convenient review. In some examples, the image(s) generated by the camera(s) include images of customers or other humans. The system, in some examples, crops the images to remove the images of the customers or other humans as the system is only concerned with the cart and cart contents.

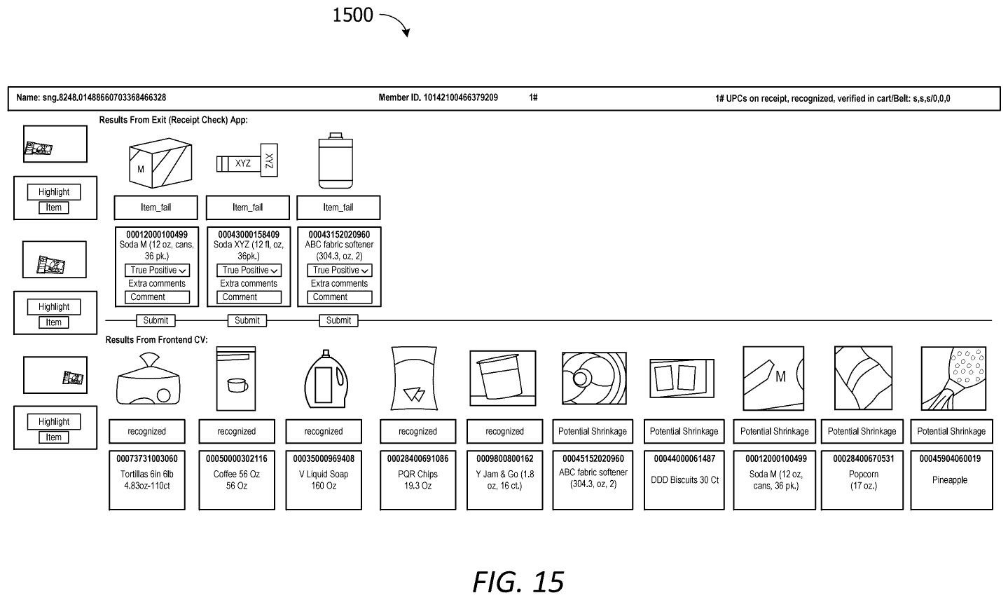

FIG. 15 is an exemplary illustration of a gallery review page 1500 including a list of paid items and a list of unpaid items. The gallery review page 1500 exhibits a list of paid items in “green” and unpaid items in “red.” However, the embodiments are not limited to displayed paid items in green and unpaid items in red. The paid and unpaid items may be displayed in any color, including black. This page is made available to the labeling team, aiding the human labelers in identifying true positive (TP) and false positive (FP) items during transaction marking. These marked items contribute to the final evaluation metrics, enhancing the accuracy of the system.

### Additional Examples

In some embodiments, the system provides an innovative exit computer vision (CV) solution designed to address the challenges faced by self-checkout (SCO) customers during the checkout process. To streamline and enhance the exit experience, the system includes an archway between the checkout terminal and the exit door of the store. The archway is a structure including one or more cameras for capturing images of the cart from multiple different angles as the cart passes through the archway. In some embodiments, the archway includes a top camera which captured a bird's eye view (top view) of the cart, as well as a camera on the right side of the arch and a camera on the left side of the arch to capture images of both sides of the cart.

The system includes a valid cart verification in which a customer walks their cart towards the exit and the system performs a quick check to ensure that it falls within the SCO camera view. The SCO may also be referred to as a scan and go (SNG). The system determines if the cart is a valid cart eligible for the exit CV process. Item recognition with CV algorithms is employed, including advanced CV algorithms, to recognize and generate a comprehensive list of items present in the cart. Fuzzy matching is used with active SCO e-receipts and the CV generated list of items. The fuzzy matching links the cart images to the corresponding SCO e-receipts ensuring accurate verification. The system then compares the results and conveniently displays a list of paid items associated with a selected e-receipt and a list of unpaid items from the CV generated list of items which fail to match to an item on the selected receipt on a gallery page. Simultaneously, this information is transmitted to the receipt check team for further verification. When the exit greeter scans the receipt barcode provided by the customer exiting the store, the receipt check system fetches and presents the results, including the list of paid and the list of unpaid items. The results are displayed to the exit greeter via a user interface associated with a user device. If all the items in the CV generated list of items have been paid for, there is no need for random scanning of one or more items in the customer's cart. If any items are included in the list of unpaid items, the exit greeter scans those identified items to verify whether those items were paid for or not rather than scanning random items. This focused approach is more accurate and time-efficient for both the associates and the customers. Moreover, this significantly reduces friction for customers and streamlines the exit process of customers for a more customer-friendly experience.

In other embodiments, the system provides an exit CV solution that streamlines the cart verification process as customers approach an exit door in a retail facility, such as a brick-and-mortar retail store. The system employs a cart detection model and object tracking algorithm to analyze images generated by one or more exit cameras to determine if a customer cart is passing through an exit camera view. It verifies the cart's trajectory (direction of travel) using a series of images of the cart in sequence, ensuring it enters from the left side of the view and exits on the right side. Representative cart image selection uses a similarity measure between the bounding box and three anchor points. The system selects representative cart images along the cart trajectory. The chosen bounding box is fully visible in the image. The computer vision item list generation leverages computer vision models, such as cart detection, item detection, depth model, classification models and verification models. The system processes the selected cart images to generate a comprehensive computer vision item list. Basket fuzzy matching utilizes the CV generated item list and precisely associates the cart image with the corresponding SCO receipt from the active SCO receipt list. Finally, the system compares the detected items, displaying a comprehensive list of paid items and unpaid items. The results are forwarded to the receipt check team for verification.

In other embodiments, the system provides an efficient exit experience for customers and store associates as well. Upon scanning the receipt barcode, the exit greeter receives the system's results. If the cart is determined to be “green to go,” this indicates all items have been paid for and there is no need for random scanning of three items in the cart, significantly reducing friction for customers. Through this optimized exit CV process, a seamless and hassle-free exit experience is provided for customers, enhancing customer satisfaction, and increasing loyalty to the retail store.

Still other embodiments provide a system to recognize and identify items that are likely to have been missed during a checkout process at an exit of a store. The system includes multiple computer vision image capture models for identifying and/or validating the cart contents with a receipt. The system validates carts to ensure they fall within the field of view of one or more cameras. The system identifies items in the cart and performs fuzzy matching between the identified items and a set of possible electronic receipts (e-receipts) associated with recent transactions. The system presents information associated with paid items and possible unpaid items in the cart based on the comparison. The system sends notifications to an exit greeter to confirm the accuracy of three-receipt more efficiently with respect to items in the cart. The notification to the exit greeter is sent with visual cues (indicators) by outlining the potentially unpaid items with bounding boxes. The system reduces the occurrence of shrink associated with the unpaid items and improves the efficiency of the exit greeters that validate the contents of a cart as it exits the store where the exit greeters need not randomly scan items in the cart or take other such steps to prevent or control potential shrink.

In some embodiments, the exit CV system enables a cart verification process and enhances the overall customer experience. For example, the system provides frictionless exit verification. Unlike traditional methods that involve stopping customers and conducting random checks, the exit CV system efficiently verifies the presence of unpaid items as customers walk their carts to the exit door without any interruption. This eliminates the need for additional random checks by the exit greeter, reducing friction and ensuring a smooth and effortless exit experience, particularly for ‘green to go’ transactions.

In some embodiments, the system enables intelligent unpaid item notification. When the system detects unpaid items in a cart, it notifies the exit greeter with visual cues, outlining the potentially unpaid items with bounding boxes. This intelligent notification mechanism is superior to the traditional receipt check, which relies on random selection. The system employs smart sampling to accurately identify potentially unpaid items, fostering greater trust and confidence in customers.

In other embodiments, the system enables comprehensive item verification. The exit CV system's advanced capabilities allow it to detect and recognize every visible item in the shopping cart. As a result, our solution can verify more paid items and effectively catch a higher number of unpaid items. This comprehensive approach to item verification ensures that losses due to shrink are minimized, leading to substantial savings and reduction in shrink. The exit CV system provides the ability to seamlessly verify carts for unpaid items without disrupting the exit process, its intelligent notification system, and its capacity to accurately verify a comprehensive range of items. These pioneering features combine to create a frictionless, trustworthy, and efficient exit experience for customers.

In one example, the system performs cart detection, item detection, item classification and verification using computer vision image analysis. The system captures images of carts as the carts are exiting the retail facility. The images are received from one or more camera devices. The system uses computer vision to detect and track the customer carts. Sample images of the carts are selected, compressed, and sent to the unpaid item manager for analysis.

In another example, the system listens for cart detected trigger indicating a cart is exiting. The system performs item detection to get cropped images of the cart. The system calls classification and verification for cropped images. Basket matching is performed to match the cart to a receipt or an e-receipt. The system saves the basket matching results and images of the cart to a cloud storage or other data storage device. The system sends the results to an ML application. This is used to recommend the number of item scans to be performed by a user at receipt check.

In still another example, the system fetches real-time shrink results from the cloud storage. The tablets or other UI devices display real-time CV results to a user for review.

Alternatively, or in addition to the other embodiments described herein, embodiments include any combination of the following:
select a first image of the selected cart in which the selected cart is located in proximity to a first anchor point within the field of view of the image capture device;
select a second image of the selected cart in which the selected cart is located in proximity to a second anchor point within the field of view of the image capture device, wherein a trained object detection model analyzes the first image and the second image to detect a plurality of items within the selected cart;
obtain a plurality of images comprising a plurality of carts;
track the selected cart through the plurality of images using object tracking;
place a bounding box around the selected cart in each image in the plurality of images;
generate a set of indicators within the selected image of the selected cart associated with the set of unpaid items, wherein each unpaid item is associated with an indicator in the set of indicators;
wherein the set of indicators comprises a bounding box associated with each unpaid item in the set of unpaid items;
display a set of images of the set of unpaid items, wherein an image of each unpaid item is included in the set of images displayed on the UI device;
a set of cameras, the set of cameras comprising a ceiling mounted camera capturing a set of images associated with a top view of the selected cart, wherein the set of cameras transmits a plurality of images of the selected cart to a computing device via a network;
selecting an image of a selected cart from a plurality of images of the selected cart using a set of anchor points associated with a field of view of an image capture device;
identifying a plurality of items associated with the selected cart using the selected image;
predicting an item identifier (ID) associated with each item in the plurality of items associated with the selected cart, a set of identified items comprising a plurality of item IDs associated with the plurality of items;
selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt;
mapping each receipt item ID in the set of paid items to a predicted item ID in the set of identified items, wherein an unmapped item in the set of identified items is a predicted unpaid item;
upon receiving a verification request signal associated with the selected receipt from a scan device indicating a user is ready to exit, generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items;
sending the notification to a user interface device associated with the scan device, the notification comprising the set of paid items and the set of unpaid items;
receiving first scan data associated with a first receipt from the scan device, the first scan data comprising a first receipt ID associated with the first receipt;
retrieving a first result including a first set of unpaid items and a first set of paid items associated with a first basket of items;
generating a first notification including the first result, wherein the first notification is transmitted to the user interface for presentation to the user in real-time;
receiving second scan data associated with a second receipt from the scan device, the second scan data comprising a second receipt ID;
retrieving a second result including a second set of unpaid items and a second set of paid items associated with a second basket of items;
generating a second notification including the second result, wherein the second notification is transmitted to the user interface for presentation to the user in real-time;
obtaining a plurality of images comprising a plurality of carts;
tracking the selected cart through the plurality of images;
placing a bounding box around the selected cart in each image in the plurality of images;
cropping each image to isolate the selected cart from other objects based on the bounding box around the selected cart in each image;
generate a list of predicted universal product code (UPC) values associated with each identified item in the set of identified items, wherein each predicted UPC in the list of predicted UPCs is mapped to a UPC associated with an item in the set of paid items obtained from the selected receipt;
displaying an image of each unpaid item in the set of unpaid items on the UI device one at a time, wherein the user is instructed to scan each item as it is displayed on the UI, wherein an image of a first unpaid item is displayed with a first instruction to scan the first unpaid item;
upon receiving scan data for a first unpaid item, displaying an image of a second unpaid item with a second instruction to scan the second unpaid item;
mapping a receipt item ID to a group of potential item IDs associated with a sub-set of items in the set of identified items;
generating a plurality of images of the selected cart by a set of cameras, the set of cameras comprising a ceiling mounted camera capturing a set of images associated with a top view of the selected cart, wherein the set of cameras transmits the plurality of images of the selected cart to a computing device via a network;
select an image of a selected cart from a plurality of images of the selected cart using a set of anchor points associated with a field of view of an image capture device;
identify a plurality of items associated with the selected cart using the selected image;
predict an item identifier (ID) associated with each item in the plurality of items associated with the selected cart, a set of identified items comprising a plurality of item IDs associated with the plurality of items;
select a receipt associated with the selected cart from a plurality of active receipts using a fuzzy matching of a set of paid items included in the selected receipt and the set of identified items generated using the selected image in real time, the set of paid items comprising a receipt item ID associated with each item scanned at a POS device during a transaction associated with the selected receipt;
map each receipt item ID in the set of paid items to an identified item ID in the set of identified items, wherein an unmapped item in the set of identified items is a predicted unpaid item;
upon receiving a verification request signal associated with the selected receipt from a scan device indicating a user is ready to exit, generate a notification including a verification result, wherein the verification result includes a set of unpaid items, wherein each predicted unpaid item in the set of unpaid items is associated with an item ID in the set of identified items that fails to map to a corresponding receipt item ID in the set of paid items;
send the notification to a user interface device associated with the scan device, the notification comprises a list of items in the set of paid items and a list of items in the set of unpaid items;
display an image of the selected cart including a set of indicators associated with the set of unpaid items;
display an image of each unpaid item in the set of unscanned items on the UI device one at a time;
estimate, by a depth model, a plurality of depth values associated with a plurality of carts within an image;
select a cart closest to an anchor point based on the plurality of depth values, wherein the depth value indicates a proximity of the selected cart to the anchor point;
the receipt item ID is a universal product code (UPC);
wherein the selected e-receipt is associated with a transaction completed at a self-checkout (SCO) device in an unstaffed checkout lane;
select a first image of the selected cart in which the selected cart is located in proximity to a first anchor point within the field of view of the image capture device;
select a second image of the selected cart in which the selected cart is located in proximity to a second anchor point within the field of view of the image capture device; and
select a third image of the selected cart in which the selected cart is located in proximity to a third anchor point within the field of view of the image capture device, wherein the first image, a trained object detection model analyzes the second image and the third image to detect a plurality of items within the selected cart.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some embodiments, the operations illustrated in FIG. 4, FIG. 5, and FIG. 6 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of identifying unpaid items via an exit CV, the method comprising selecting an image of a selected cart from a plurality of images of the selected cart using a set of anchor points associated with a field of view of an image capture device; identifying a plurality of items associated with the selected cart using the selected image; predicting an item identifier (ID) associated with each item in the plurality of items associated with the selected cart, a set of identified items comprising a plurality of item IDs associated with the plurality of items; selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt; mapping each receipt item ID in the set of paid items to a predicted item ID in the set of identified items, wherein an unmapped item in the set of identified items is a predicted unpaid item; upon receiving a verification request signal associated with the selected receipt from a scan device indicating a user is ready to exit, generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and sending the notification to a user interface device associated with the scan device, the notification comprising the set of paid items and the set of unpaid items.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for identifying unpaid items. For example, the elements illustrated in FIG. 1, FIG. 2, and FIG. 3, such as when encoded to perform the operations illustrated in FIG. 4, FIG. 5, and FIG. 6, constitute exemplary means for selecting an image of a selected cart from a plurality of images of the selected cart using a set of anchor points associated with a field of view of an image capture device; exemplary means for identifying a plurality of items associated with the selected cart using the selected image; exemplary means for predicting an item identifier (ID) associated with each item in the plurality of items associated with the selected cart, a set of identified items comprising a plurality of item IDs associated with the plurality of items; exemplary means for selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt; exemplary means for mapping each receipt item ID in the set of paid items to a predicted item ID in the set of identified items, wherein an unmapped item in the set of identified items is a predicted unpaid item; exemplary means for generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and exemplary means for sending the notification to a user interface device associated with the scan device, the notification comprising the set of paid items and the set of unpaid items.

Other non-limiting embodiments provide one or more computer storage devices having a first computer-executable instructions stored thereon for providing identification of unpaid items. When executed by a computer, the computer performs operations including selecting an image of a selected cart from a plurality of images of the selected cart using a set of anchor points associated with a field of view of an image capture device; identifying a plurality of items associated with the selected cart using the selected image; predicting an item identifier (ID) associated with each item in the plurality of items associated with the selected cart, a set of identified items comprising a plurality of item IDs associated with the plurality of items; selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned at a POS device during a transaction associated with the selected e-receipt; mapping each receipt item ID in the set of paid items to a predicted item ID in the set of identified items, wherein an unmapped item in the set of identified items is a predicted unpaid item; generating a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and sending the notification to a user interface device associated with the scan device, the notification comprising the set of paid items and the set of unpaid items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” only one of or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for zero-friction unpaid item identification via computer vision, the system comprising:
a processor; and
a computer-readable medium storing instructions that are operative upon execution by the processor to:
select an image of a selected cart from a plurality of images of the selected cart using a set of anchor points associated with a field of view of an image capture device;
identify a plurality of items associated with the selected cart using the selected image;
predict an item identifier (ID) associated with each item in the plurality of items associated with the selected cart, a set of identified items comprising a plurality of item IDs associated with the plurality of items;
select a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned during a transaction associated with the selected e-receipt;
map each receipt item ID in the set of paid items to an identified item ID in the set of identified items, wherein an unmapped item in the set of identified items is a predicted unpaid item;
upon receiving a verification request signal associated with the selected e-receipt from a scan device indicating a user is ready to exit, generate a notification including a verification result, wherein the verification result includes a set of unpaid items, wherein each predicted unpaid item in the set of unpaid items is associated with a predicted item ID in the set of identified items that fails to map to a corresponding receipt item ID in the set of paid items; and
send the notification to a user interface (UI) device associated with the scan device, the notification comprises a first list of items in the set of paid items and a second list of items in the set of unpaid items.

2. The system of claim 1, wherein the instructions are further operative to:
select a first image of the selected cart in which the selected cart is located in proximity to a first anchor point within the field of view of the image capture device; and
select a second image of the selected cart in which the selected cart is located in proximity to a second anchor point within the field of view of the image capture device, wherein a trained object detection model analyzes the first image and the second image to detect the plurality of items within the selected cart.

3. The system of claim 1, wherein the instructions are further operative to:
obtain the plurality of images comprising a plurality of carts;
track the selected cart through the plurality of images using object tracking; and
place a bounding box around the selected cart in each image in the plurality of images.

4. The system of claim 1, wherein the instructions are further operative to:
generate a set of indicators within the selected image of the selected cart associated with the set of unpaid items, wherein each unpaid item is associated with an indicator in the set of indicators.

5. The system of claim 1, wherein the set of indicators comprises a bounding box associated with each unpaid item in the set of unpaid items.

6. The system of claim 1, wherein the instructions are further operative to:
display a set of images of the set of unpaid items, wherein an image of each unpaid item is included in the set of images displayed on the UI device.

7. The system of claim 1 further comprising:
a set of cameras, the set of cameras comprising a ceiling mounted camera capturing a set of images associated with a top view of the selected cart, wherein the set of cameras transmits the plurality of images of the selected cart to a computing device via a network.

8. A method for zero-friction unpaid item detection, the method comprising:
selecting an image of a selected cart from a plurality of images of the selected cart using a set of anchor points associated with a field of view of an image capture device;
identifying a plurality of items associated with the selected cart using the selected image;
predicting an item identifier (ID) associated with each item in the plurality of items associated with the selected cart, a set of identified items comprising a plurality of item IDs associated with the plurality of items;
selecting a e-receipt associated with the selected cart from a plurality of active e-receipts using a fuzzy matching of a set of paid items included in the selected e-receipt and the set of identified items generated using the selected image in real time, the set of paid items comprising a receipt item ID associated with each item scanned during a transaction associated with the selected e-receipt;
mapping each receipt item ID in the set of paid items to the predicted item ID in the set of identified items, wherein an unmapped item in the set of identified items is a predicted unpaid item;
upon receiving a verification request signal associated with the selected receipt from a scan device indicating a user is ready to exit, generating a notification including a verification result, wherein the verification result includes a set of unpaid items, wherein each predicted unpaid item in the set of unpaid items is associated with the predicted item ID in the set of identified items that fails to map to a corresponding receipt item ID in the set of paid items; and
sending the notification to a user interface (UI) device associated with the scan device, the notification comprising the set of paid items and the set of unpaid items.

9. The method of claim 8, further comprising:
receiving first scan data associated with a first receipt from the scan device, the first scan data comprising a first receipt ID associated with the first receipt;
retrieving a first result including a first set of unpaid items and a first set of paid items associated with a first basket of items;
generating a first notification including the first result, wherein the first notification is transmitted to the UI device for presentation to the user in real-time;
receiving second scan data associated with a second receipt from the scan device, the second scan data comprising a second receipt ID;
retrieving a second result including a second set of unpaid items and a second set of paid items associated with a second basket of items; and
generating a second notification including the second result, wherein the second notification is transmitted to the UI device for presentation to the user in real-time.

10. The method of claim 8, further comprising:
obtaining images comprising a plurality of carts;
tracking the selected cart through the images;
placing a bounding box around the selected cart in each image in the images; and
cropping each image to isolate the selected cart from other objects based on the bounding box around the selected cart in each image.

11. The method of claim 8, further comprising:
generate a list of predicted universal product code (UPC) values associated with each identified item in the set of identified items, wherein each predicted UPC in the list of predicted UPC values is mapped to a UPC associated with an item in the set of paid items obtained from the selected receipt.

12. The method of claim 8, further comprising:
displaying an image of each unpaid item in the set of unpaid items on the UI device one at a time, wherein the user is instructed to scan each item as it is displayed on the UI device, wherein an image of a first unpaid item is displayed with a first instruction to scan the first unpaid item; and
upon receiving scan data for the first unpaid item, displaying an image of a second unpaid item with a second instruction to scan the second unpaid item.

13. The method of claim 8, further comprising:
mapping a receipt item ID to a group of potential item IDs associated with a sub-set of items in the set of identified items.

14. The method of claim 8, further comprising:
generating the plurality of images of the selected cart by a set of cameras, the set of cameras comprising a ceiling mounted camera capturing a set of images associated with a top view of the selected cart, wherein the set of cameras transmits the plurality of images of the selected cart to a computing device via a network.

15. One or more computer storage devices having computer-executable instructions stored thereon, which, upon execution by a computer, cause the computer to perform operations comprising:
select an image of a selected cart from a plurality of images of the selected cart using a set of anchor points associated with a field of view of an image capture device;
identify a plurality of items associated with the selected cart using the selected image;
predict an item identifier (ID) associated with each item in the plurality of items associated with the selected cart, a set of identified items comprising a plurality of item IDs associated with the plurality of items;
select a receipt associated with the selected cart from a plurality of active receipts using a fuzzy matching of a set of paid items included in the selected receipt and the set of identified items generated using the selected image in real time, the set of paid items comprising a receipt item ID associated with each item scanned during a transaction associated with the selected receipt;
map each receipt item ID in the set of paid items to an identified item ID in the set of identified items, wherein an unmapped item in the set of identified items is a predicted unpaid item;
upon receiving a verification request signal associated with the selected receipt from a scan device indicating a user is ready to exit, generate a notification including a verification result, wherein the verification result includes a set of unpaid items, wherein each predicted unpaid item in the set of unpaid items is associated with an item ID in the set of identified items that fails to map to a corresponding receipt item ID in the set of paid items; and
send the notification to a user interface (UI) device associated with the scan device, the notification comprises a first list of items in the set of paid items and a second list of items in the set of unpaid items.

16. The one or more computer storage devices of claim 15, wherein the operations further comprise:
display an image of the selected cart including a set of indicators associated with the set of unpaid items; and
display an image of each unpaid item in the set of unpaid items on the UI device one at a time.

17. The one or more computer storage devices of claim 15, wherein the operations further comprise:
estimate, by a depth model, a plurality of depth values associated with a plurality of carts within an image; and
select a cart closest to an anchor point based on the plurality of depth values, wherein the depth value indicates a proximity of the selected cart to the anchor point.

18. The one or more computer storage devices of claim 15, wherein the receipt item ID is a universal product code (UPC).

19. The one or more computer storage devices of claim 15, wherein a selected e-receipt is associated with a transaction completed at an unstaffed checkout lane.

20. The one or more computer storage devices of claim 15, wherein the operations further comprise:
select a first image of the selected cart in which the selected cart is located in proximity to a first anchor point within the field of view of the image capture device;
select a second image of the selected cart in which the selected cart is located in proximity to a second anchor point within the field of view of the image capture device; and
select a third image of the selected cart in which the selected cart is located in proximity to a third anchor point within the field of view of the image capture device, wherein the first image, a trained object detection model analyzes the second image and the third image to detect a plurality of items within the selected cart.
